(19) United States
(12) Patent Application Publication
(10) Pub. No.: US 2012/0144301 A1
(43) Pub. Date: Jun. 7, 2012

(54) METHOD AND SYSTEM FOR A VIRTUAL TRAINING AND COACHING SERVICE

(76) Inventor: Eric BASS, New Hope, PA (US)

(21) Appl. No.: 13/309,236

(22) Filed: Dec. 1, 2011

Related U.S. Application Data
(60) Provisional application No. 61/418,778, filed on Dec. 1, 2010.

(51) Int. Cl. G06F 3/01

(52) U.S. Cl. 715/709; 715/744; 715/738

(57) ABSTRACT

The present invention relates to a method and system using an online website that provides personalized and comprehensive fitness, nutrition, motivation, and training information to registered users, typically without directing them to other sites or requiring the purchase of products. The invention provides an interactive, easy to use, personalized homepage for each user. The user has access to selectable Modules focused on different areas of fitness which open within the personalized homepage to help them improve general fitness ability, strength, speed, agility and flexibility or aid in prevention of and recovery from injuries while providing nutritional guidance, injury prevention and treatment tips, and/or coaching instructions.

### CROSS REFERENCE TO RELATED APPLICATIONS

This Non-provisional application claims the benefit of priority to U.S. Provisional Application No. 61/418,778 filed Dec. 1, 2010, the entire contents of which are hereby incorporated by reference.

### BACKGROUND OF THE INVENTION

The invention relates to an online website that provides personalized and comprehensive fitness, nutrition, motivation, and training information to registered users, typically without directing them to other sites or requiring the purchase of products. The invention provides an interactive, easy to use, personalized homepage for each user. The user has access to modules which open within the personalized homepage to help them improve general fitness ability, strength, speed, agility and flexibility, or aid in prevention of and recovery from injuries while providing nutritional guidance, injury prevention and treatment tips, and coaching instructions.

At every level of sports, strength, speed, and proper nutrition are often major keys to better athletic performance. However, training options for young athletes and their families are limited, expensive and require visits to training facilities, the hiring of personal trainers and/or the purchase of DVDs and other training materials. Although many adolescents participate in athletic activities, the all-important strength and conditioning training options available to them are often limited to practices and coaching through school and community leagues. These leagues do not reach out to all children, and the coaches and league officials do not have the knowledge, equipment, experience and resources required for young athletes to reach their full potential. With childhood obesity on the rise, motivating and encouraging children to not only begin exercising, but to continue and progress to higher levels is essential to student populations, adults, and athletes of all ages.

Existing website-based training services are often directed at adults, and do not provide a personalized and comprehensive site of all training and fitness related information. Existing training websites and programs typically focus on individuals, often adults, and do not promote entire families becoming involved.

Existing sites also do not provide a means for individuals to receive ongoing training, especially in the area of rehab that allows them to continue physical rehab in the case of an injury or any other health problem.

For example, U.S. Pat. No. 7,169,085 to Killin et al (“Killin”) describes a method and system for generating an exercise prescription based on a user's self-assessed functional capacity, goals, specific injury, health condition, disease, or surgery. Killin teaches that this method and system can be provided using audio and video delivered by the Web, DVD, TV, radio frequency, satellite or other medium. However, this system and method of Killin involve complex interactions and communications between the user and a database and further does not provide all of the information on one easy to access and view user interface. Although Killin describes how a specific exercise program will be generated by having a user answer questions presented to them, there is no focus on young athletes and no description of a single, easy to use interface that displays all information through one website. Killin can also be used to replace conventional physical therapy sessions. The focus of the present invention is not to replace conventional physical therapy, but rather to extend and enhance its benefits. Killin generates a specific protocol of exercises based on a targeted musculoskeletal structure or results of a questionnaire survey. In contrast, the present invention provides an interactive menu of many different areas of health and fitness, which includes a wide range of training exercises that a user may select from at all times.

Additionally, U.S. Pat. No. 6,461,162 to Reitman et al (“Reitman”) relates to methods by which a team of consultants assists participants in athletic endeavors and physical activity attempting to enhance athletic performance. Reitman uses an interface that allows remote connection between a user and an information data base enabling interactive communication wherein the database and information is tailored to a specific athlete for a specific sport. However, Reitman is not directed specifically the needs of young athletes, and further does not provide a single, easy to use webpage within which all information is presented to the user. Instead, there are different areas of the website accessed through specific activities or areas of interest. Reitman also stresses the development of serious athletes, tailoring information specific to that athlete instead of providing information related to any user wishing to develop and overall healthier lifestyle.

The lack of an integrated software platform that can provide all aspects of virtual coaching to young athletes has meant that many do not have access to the types of training necessary for them to become faster, stronger, and to compete at higher levels along with decreasing the incidence of injury significantly through better conditioning preparation for the sports they play.

### SUMMARY OF THE INVENTION

To overcome these problems, one aspect of the present invention allows training exercises, nutrition information, motivational tips, and coaching advice to all be accessed through one website. The present invention provides users with training advice and techniques adjusted for their specific ability, skill and age levels, athletic ability, and helps them to progress from one level to the next. The training advice and techniques are not organized by specific sport, but are rather organized according to the area of fitness or health that any user may wish to improve. The present invention does not focus on sport-specific exercises like many other website- based training programs, but rather with general strengthening exercises that can be applied to all sports to foster better athletic abilities in athletes while reducing the likelihood of injuries.

Unlike other website-based training and fitness programs, in one embodiment, the current invention does not promote users to purchase products or link onto advertisements or other websites for their fitness training needs. Instead, a goal of the current invention is to provide all of the information that users will need on one personalized homepage. The personalized homepage allows users to navigate around the site to all of the different informational modules without ever leaving the homepage itself. Instead of links that move the user from one web page to another, the personalized homepage provides a series of drop-down menus and windows from easily identifiable tabs. By keeping the user on one personalized homepage, users can easily move from one informational module to another and can also keep track of where they are within each module.

In an alternative embodiment, selection of one of the informational modules on the user's homepage may direct that user to a separate webpage directed to that module. A series of drop-down menus and windows from easily identifiable tabs are provided to the user within the selected module webpage. Alternatively, instead of drop-down menus, each new level of selectable options may be presented on a successive webpages that are displayed to the user as the user makes selections. This embodiment allows users to focus on one particular area of training or fitness by providing an easy, interactive webpage containing information and instructions relating to the selected module.

In one aspect, the current invention provides each registered user with a personalized homepage that is accessed upon completing a login. After logging in to their personalized homepage, the user does not need to link out to any other web pages to receive their fitness and training information and instructions. The personalized homepage is a simple, user-friendly website from which the user is able to access all of the training, fitness, motivation, and advice modules which are displayed as Tabs. The user may select modules on his own or may choose to have a personalized coach through the Coaches Corner Tab to help make the selections based on the user's progress and fitness goals. Upon selecting a certain module, the user is generally not directed to a new webpage or linked to another site. Instead, the selected module opens within the user's personalized homepage, with all options for training or fitness instructions being displayed within the module window. The user then selects from options within the module, with each selection resulting in a new window opening within the module. The user continues to select from the displayed options until they are given a video, audio, or text that instructs them on the fitness or lifestyle activity on which they are working. Because the user never leaves the homepage and has all selected options open in a set of layers, the user is able to see all previous selections they have made and can easily change from one module or option to another.

Another aspect of the present invention is a virtual coach available to the user that provides training instructions, suggested exercises, motivation, health tips, and suggestions for the user to meet goals or move on the next level. The virtual coach may take the form of a video-recorded human image, an animated figure that appears on the user's homepage, audio speech that talks to the user as the user navigates their homepage, text boxes that appear in different areas of the user's homepage, or any other means of communication. The virtual coach may act as an instructional guide and/or direct the user to specific modules and exercises that will help the user to reach the next level in their training program.

Another aspect of the present invention is that the website-based training program provides useful information and training program suggestions for those such as inexperienced or nonprofessional coaches, community sports leagues, scholastic sports leagues, and scholastic physical education departments. The website-based training program provides all information necessary for these coaches and organizations to help young athletes or students achieve higher levels of performance or a healthier lifestyle without having to hire and bring in additional staff or experts.

In another embodiment of the present invention is the website does not rely on advertising dollars, as do most other website-based training systems, and does not require or urge users to purchase additional books, videos or other materials. Instead, the present invention charges a set fee for each family or individual that signs up, and pays out a monthly percentage dividend to a participating organization, representative or member for each new member signed up by referral from that current member. This fee and dividend structure provides an incentive for individuals to recruit others in their communities, companies, sports leagues, and schools to also register for website-based training of the present invention. This structure is especially important for schools and community organizations, as it allows them a way to help fund their programs through the monthly dividends while also providing a training program to assist young athletes, students and others in achieving greater success in athletic competitions as well as greater overall health and injury prevention exercises. It also provides a way for companies to earn greater revenues that would not have been realizable otherwise. The invention allows companies to expand their business into areas and markets that they would not have been able to reach otherwise.

Another aspect of the present invention relates to a system for implementing the training and fitness program. This system may include a user interface, database, server, and application program. The user interface can be a computer, tablet computer, PDA, smart phone, cellular phone, or any other device that has internet connectivity and a display screen. The system can further include the application program stored on a computer readable medium within a device that contains communication capability with the database. This application allows a user to enter information or upload videos, which are sent through the server to the database. A host computer then accesses the databases and provides feedback to the user based on the information or videos provided by the user. The host computer, through the server and database, places this feedback information on the user's personalized website and also automatically updates the user's personalized website to customize the options and levels based on any new information the user has entered.

Additional aspects of the invention are described below.

### BRIEF DESCRIPTION OF THE FIGURES

FIG. 1 is a representative screen shot of the introduction and log in page;

FIG. 2 is a representative screen shot of a registered user's personalized homepage, including a virtual coach;

FIG. 3 is a representative screen shot of a personalized homepage with the Motivational Exercises Module selected and demonstrating a textual information drop down option being selected in the display.

FIG. 4 is a representative screen shot with the Training Exercises Module selected.

FIG. 5 is a representative screen shot of demonstrating the display of the present invention on a user's personalized homepage.

FIG. 6 is an expanded view of the display drop down menus showing a video representation of a specific exercise.

FIG. 7 is a representative screen shot of a personalized homepage with the Nutrition Module selected.

FIG. 8 is a representative screen shot of a personalized homepage with the Injury Prevention & Treatment Tips Module selected.

FIG. 9 is a representative screen shot of a personalized homepage with the Get Out and Play Module and Simple Outdoor Fun option selected.

FIG. 10 is a representative screen shot of a personalized homepage with the Creating Exercise Equipment Module selected and showing a video demonstration in the drop down windows of using homemade equipment.

FIG. 11 is a representative screen shot of a personalized homepage with representative informational articles for parents and young athletes displayed while the Did You Know Module is selected.

FIG. 12 is a representative screen shot of a personalized homepage with the Coach's Corner Module selected demonstrating options for interactive communication with an experienced trainer or coach.

FIG. 13 is a representative screen shot of a personalized homepage with the Articles of Interest Module selected.

FIG. 14 is a diagram of the software platform and its associated modules and users.

### DETAILED DESCRIPTION OF THE INVENTION

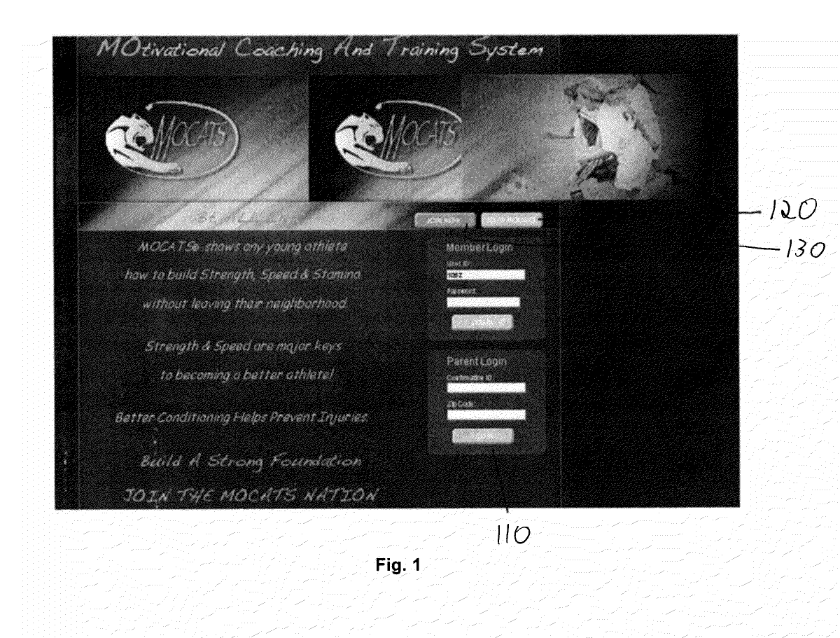

The present invention provides a personalized, comprehensive online fitness and training website for registered users. As seen in FIG. 1, registered users are able to login to the user's personalized homepage by entering their user name and password and clicking on the LOGIN icon 110. Potential users who access the website for the first time are given the option of taking a tour of the online fitness and training system of the present invention by clicking the TOUR MOCATS icon 120.

Any non-registered visitors to the website can select a JOIN NOW icon 130 (FIG. 1). Upon selection of JOIN NOW 130, the user is immediately directly to a private third-party vendor who provides a secure registration format. The registration menu requests that the user input certain personal information about the joining member(s), including age, grade, gender, and athletic activity involvement. The registration menu also requests that the user select or input certain fitness or sport-specific goals so that the website can personalize training suggestions upon the completion of the registration process. A user is also directed to enter personal information about themselves for billing purposes (i.e.: parent name, address, email, and credit card information). In the case of families registering with the website, a parent or guardian can enter information about all family members requesting membership during the same registration. This allows for parents/guardians to monitor the progress of their children, and also allows the parents to access information on the website to assist in the training and progress of each registered child. The parent/guardian may monitor the progress and activity of family members by signing in under a Parental Login option. Parents/guardians are given the capability to remove family members from registration, to deny access of a registered family member at any time, and to restrict the times during which registered family members may access the website.

Payment of a fee is required to complete the registration process and is also required after certain set time periods of use, such as on a monthly basis. No additional payments or purchases are required to begin training. In various embodiments, the website-based fitness program of the present invention does not require users to purchase any additional books, videos, or training equipment. Instead, all aspects of the fitness training program are displayed to the user on a personalized homepage that the user accesses each time they sign into the website. Although users are required to pay a fee to access the personalized training website, the present invention also provides a system through which registered users, organizations, companies, or representatives can receive a monthly percentage dividend of fees from each additional user that they refer. This fee and dividend structure provides an incentive for individuals, coaches, schools, companies and youth athletic organizations to recruit families with young athletes to register with the website-based training of the present invention. This structure is especially important for schools and community organizations, as it allows them a way to help fund their programs through the monthly dividends while also providing a training program to assist young athletes and students in achieving greater success in athletic competitions by becoming stronger and faster, as well as increasing overall health and helping prevent injuries through sport specific exercise instruction. It also provides a way for companies to earn greater revenues that would not have been realizable otherwise. The invention allows companies to expand their business into areas and markets that they would not have been able to reach otherwise.

In one aspect of the invention, a virtual coach specifically set to each user is created based upon the registration information entered. This virtual coach appears on the user's personalized homepage and directs the user to selections within the Modules that will help the user achieve specific goals or advance to the next progression level. The virtual coach may take the form of a video-recorded human figure, an animated figure that appears on the user's homepage, audio speech that talks to the user as the user navigates their homepage, text boxes that appear in different areas of the user's homepage, or any other means communication.

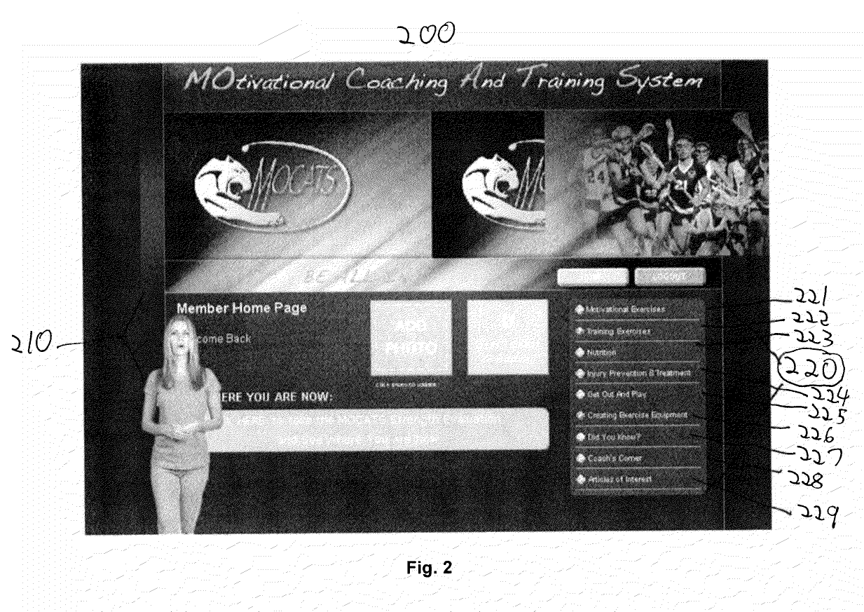

The personalized home page 200 of a registered user is represented in FIG. 2. The personalized home page 200 displays the user's name, current level, and the next level that the user is working towards in display 210. As seen in FIG. 2, the virtual fitness coach can appear in a video overlay on the personalized homepage. This allows the virtual fitness coach to provide audible and visual communications, instructions, and physical demonstrations to the user. One feature of the present invention is developing registered user's athletic skills, fitness levels, and overall health by providing steps for advancing from one level to the next. The invention keeps track of all exercises performed, nutritional habits, and activity on the personalized homepage to determine current and future levels of each user. In order to advance from one level to the next, the user completes different levels of training exercises and reaches goals specified on the user's homepage.

When a user first logs into their personalized homepage, the website presents a selectable icon on the user display for the user to take a strength and fitness evaluation to determine the user's current fitness level. Upon selecting this icon, a window opens on the personalized homepage describing different exercises to be performed and asking the user to enter certain information upon completion. The strength and fitness evaluation may ask the user to enter the number of repetitions performed in a variety of exercises. The exercises are pre-rated to determine the level of the user according to both repetitions performed and difficulty of the exercise. Based on this information entered by the user, the website based fitness program determines the user's current fitness level, and configures the virtual coach and selectable Modules accordingly. The personalized homepage displays the number of days until a user will again take a strength and fitness evaluation so that the user is always informed of how progress will be measured. The personalized homepage displays the results of each exercise from the most recent evaluation, along with the corresponding level for that exercise. The homepage also displays a goal for each exercise for the next time user takes the strength and fitness evaluation. Users may be placed at different levels for different exercises and training options depending on the results of the evaluation.

As an alternative to entering numerical information for the website based fitness program of the present invention to determine current fitness levels of a registered user, the user may submit video of the performance of the different evaluation tasks and exercises. The present invention may also cooperate with an interactive system that is able to monitor and track a user's movements in real time. The results of the interactive system's tracking of the user's movements for each exercise may be communicated to the user's personalized homepage or the system server of the present invention.

The personalized home page 200 also includes all of the selectable modules 220 which the user selects to receive training and fitness demonstrations, information, and videos. These modules, selectable by the user or automatically selectable by the user's virtual coach, include a Motivational Exercises Module 221, a Training Exercises Module 222, a Nutrition Module 223, an Injury Prevention and Treatment Module 224, a Get Out and Play Module 225, a Creating Exercise Equipment Module 226, a Did You Know? Module 227, a Coach's Corner Module 228, and an Articles of Interest Module 229. When the user makes the selections, the user can manually select different modules displayed on the user interface. Additionally, the interactive website based exercise system can automatically direct a user to different modules based on information stored in the database from the user's last visit to their personalized homepage.

Another aspect of the present invention is a coupon distribution box available as a selectable icon on the user's personalized homepage or within selected Modules and options. The coupon box may also be provided as a selectable icon on the parent/guardian's homepage. This coupon box may provide coupons or announcements of special discounts at various stores, including grocery stores, school supplies stores, sporting goods stores, or any other products related to physical fitness and training. The contents of the coupon box may change depending on the selections made by the user so they are customized to the information the user is actively selecting on the website. For example, the coupon box on the personalized homepage may display coupons or announcements of discounts relating to grocery store products when the user selects the Nutrition Module. The contents could then change to coupons and announcements of discounts for pain relief, first aid and related products when the user selects the Injury Prevention & Treatment Module. This coupon box may appear as a separate selectable icon on the user's personalized homepage, or the coupons may appear as part of the drop down windows in any selected Module.

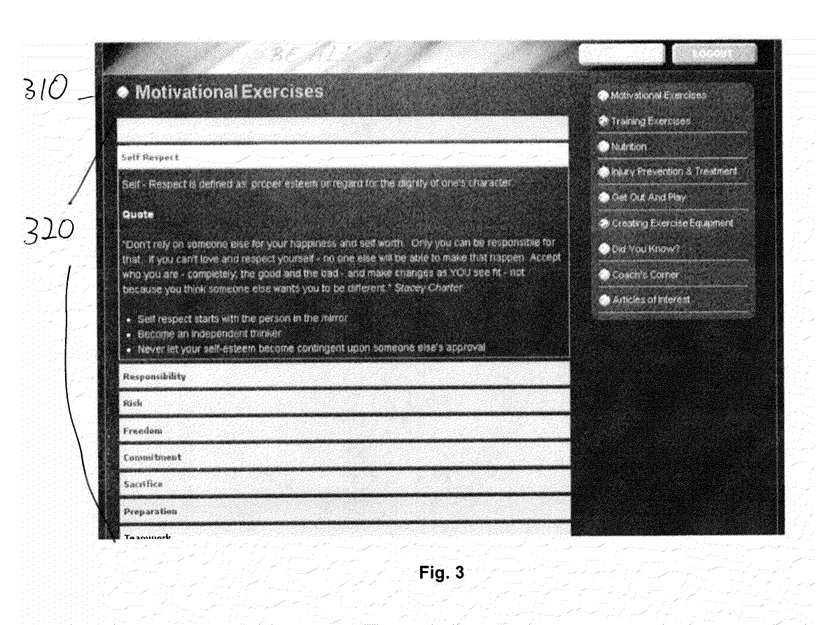

Upon selection of a Module 221-229, the personalized homepage displays the title of the selected Module and provides additional, selectable options below this Module title. As seen in FIG. 3, the user is not redirected from their personalized homepage after selecting a Module. Instead, the personalized homepage displays the title of the selected module 310, and provides further selectable options 320 below the Module title. The registered user selects from these options 320, either by their own decision or through their virtual coach, in order to continue to navigate to the exercise or fitness information required to meet their goals.

In an alternative embodiment, selection of a Module may direct a user to a new webpage that is specific to that Module. In this embodiment, the personalized homepage is replaced by a Module homepage that contains the selectable options for that selected Module. The user may return to their personal homepage through a link on the selected Module homepage.

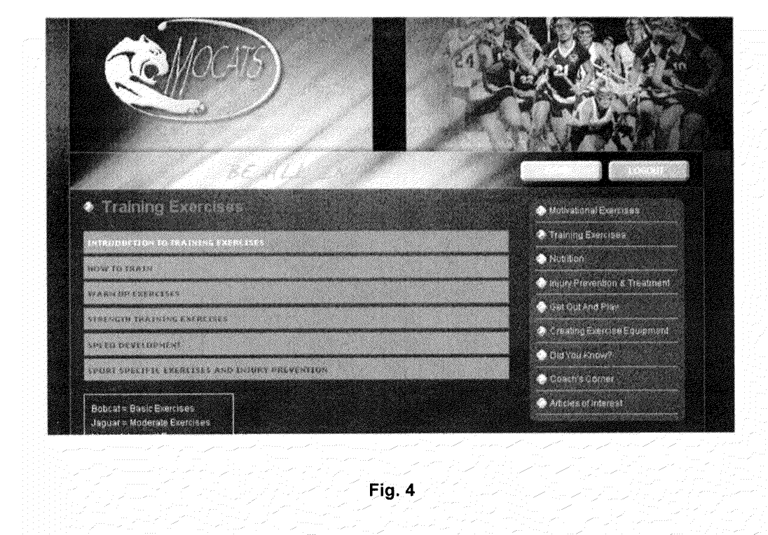

FIG. 4 demonstrates the personalized homepage with the Training Exercises Module selected. Under this Module, the user is able to select from general exercise and training, or can select from options providing information for specific sports or injuries.

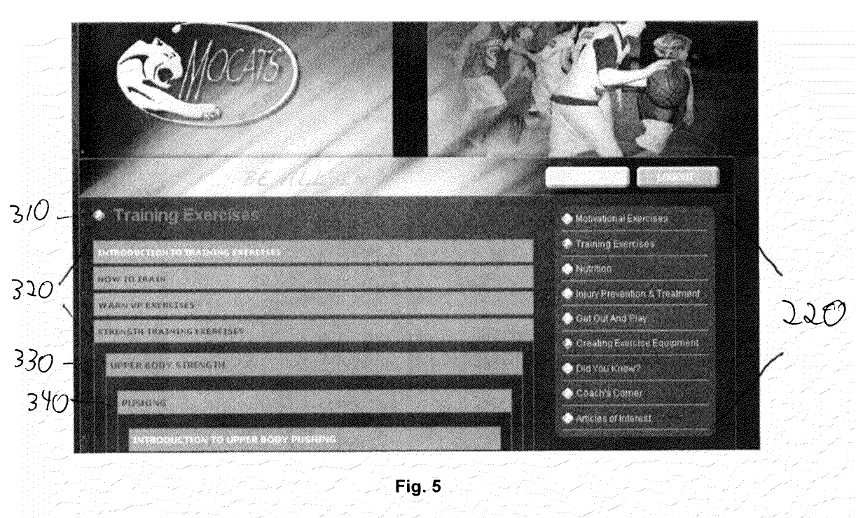

FIG. 5 demonstrates the user's selecting further options without leaving their personalized homepage and viewing all previously selected options. The user makes a first level selection of available options 320, then selections from options 330 displayed to the user in a window that drops down from selected option 320. Within option 330, the user selects from options 340 displayed in a window that drops down from selected option 330. The selectable Modules 220 remains displayed on the personalized homepage, allowing the user to select a different Module at any time. At each level of selectable options, the user's virtual coach may provide guidance in the form of on-screen video, text messages on the homepage, and/or audio messages to the user. For example, based on the user's level of progress, sports season, or entered goals, the virtual coach could suggest certain exercises or remind the user which exercises will need to be completed to move up to the next level or reach a specified goal. Additionally, the virtual coach may display options selectable by the user that will guide the user to different Modules and options within the options. For example, the virtual coach may present a menu of options asking the user which sport they are currently focusing on. Upon selection of a sport, the virtual coach may then ask which skill area within that sport the user wishes to improve. Upon selection of a skill area, the virtual coach may then present the user with selectable icons directing them to Modules and options within Modules that will provide the information the user requires.

In an alternative embodiment, once a Module is selected a user may be directed to a specific webpage for that Module, wherein additional selectable options are displayed within that webpage. Instead of a series of drop-down menus as discussed above, each selection opens a new webpage containing the next level of options available to the user. Selection of each additional option links the user to a new screen with the next level of selectable options displayed, and a link allowing the user to return to the previous selection page or to the user homepage. In this manner, the invention allows for a user to progress to specific areas of information or instruction through a series of pages for each level of selectable options. For example, a user selecting the Training Exercises Module may be directed to a Training Exercises Module webpage. This Training Exercises Module webpage displays selected options for the type of strength training the user is currently searching for, such as warm up, strength exercises, speed exercise, or injury prevention. Upon selection of one of these options, the user is directed to a new page that displays the next level of options.

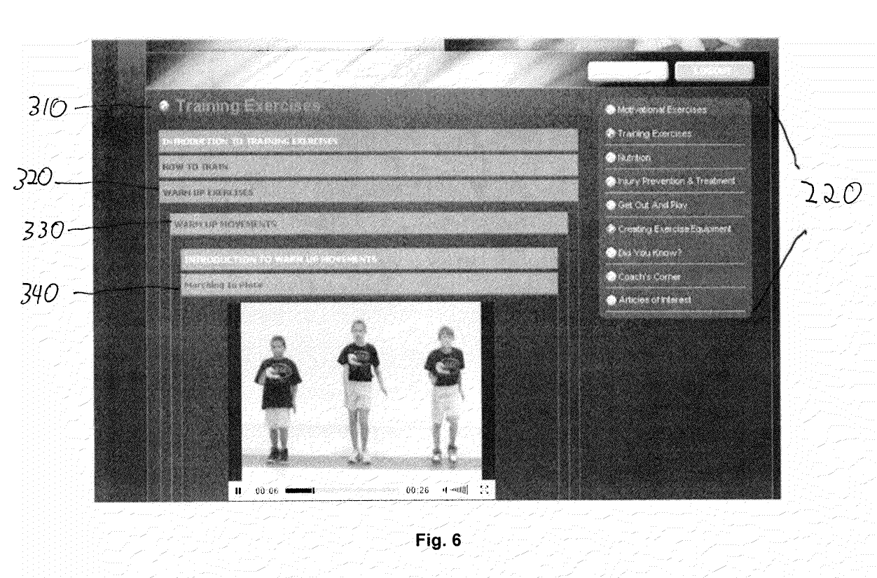

As seen in FIG. 6, when the user selects an option from the final displayed group of options under one of the Modules 220, the window that drops down provides the user with text, video, and/or audio. In one aspect of the invention, the text, audio or videos may only be accessed by a user once that user has registered. The text, audio or video displayed to the user may be stored in a central database connected to a server. For example, under the Training Exercises Module shown in FIG. 5, window 340 drops down and displays a video on the proper method to perform the warm up movement of “Marching in Place.” The user's previous selections of Training Exercises 310, Warm Up Exercises 320, and Warm up Movements 330 are all still displayed in on the user's personalized homepage. Therefore, the user can easily track their selections under each Module. The Training Exercises Module displayed in FIG. 6 provides users with audio and/or video demonstrations of exercises and training techniques along with textual descriptions of each exercise. For example, the Training Exercises Module shown in FIGS. 4-6 may include selectable options for an Introduction, How to Train, Warm Up Exercises, Strength Training Exercises, Speed Development, and Sports Specific Exercises and Injury Prevention. Under each selectable option, the user chooses from further options displayed as drop-down windows within each selection made. The options available to the user specify areas of the body, techniques and athletic positions that the user wishes to improve.

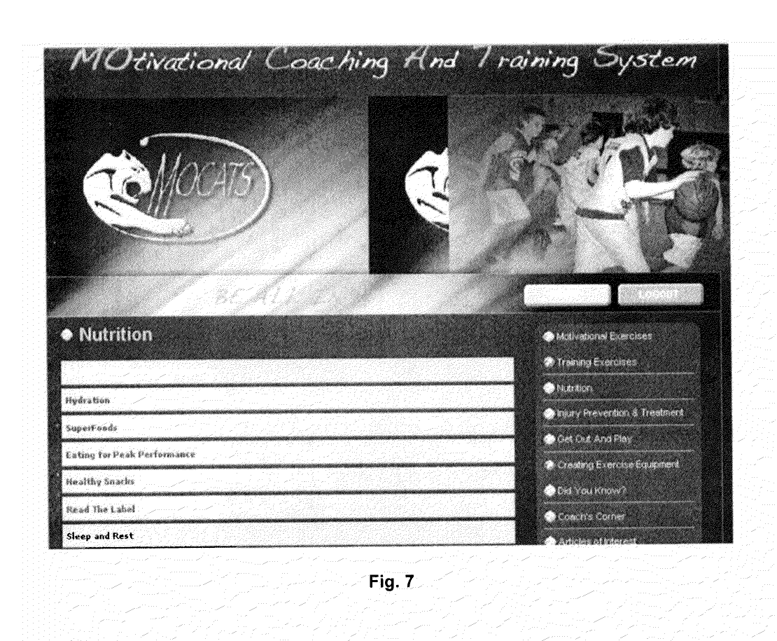

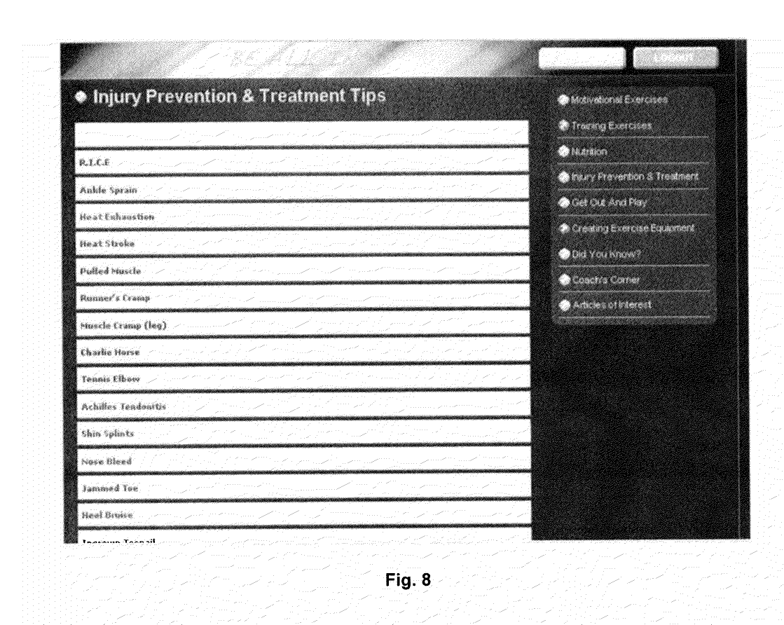

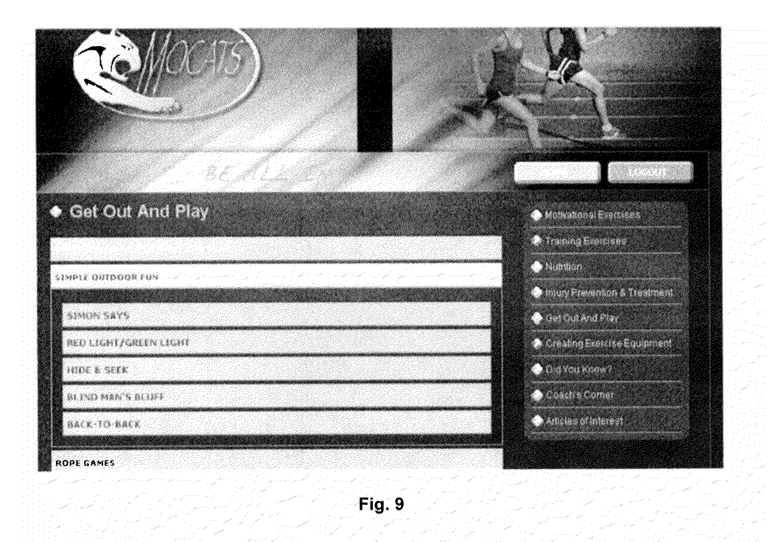

FIGS. 7-9 are examples of a user's personalized homepage with the Nutrition Module, Injury Prevention & Treatment Tips Module, and Get Out and Play Modules selected. To select between the different Modules, the user does not navigate away from the personalized homepage. Instead, the user simply selects a different Module from the display of selectable Modules that is constantly present on the homepage. The Nutrition Module and Injury Prevention & Treatment Modules provide information for the registered user to maintain a healthy diet and to both prevent and treat specific injuries. The Get Out and Play Module provides descriptions of various physical activities for athletes and users of different age ranges. One feature of the Get Out and play Module is to provide descriptions of games and activities, including the rules and lists of any equipment required. This Module is useful for both the young athletes themselves, and also for parents or Physical Education departments in schools.

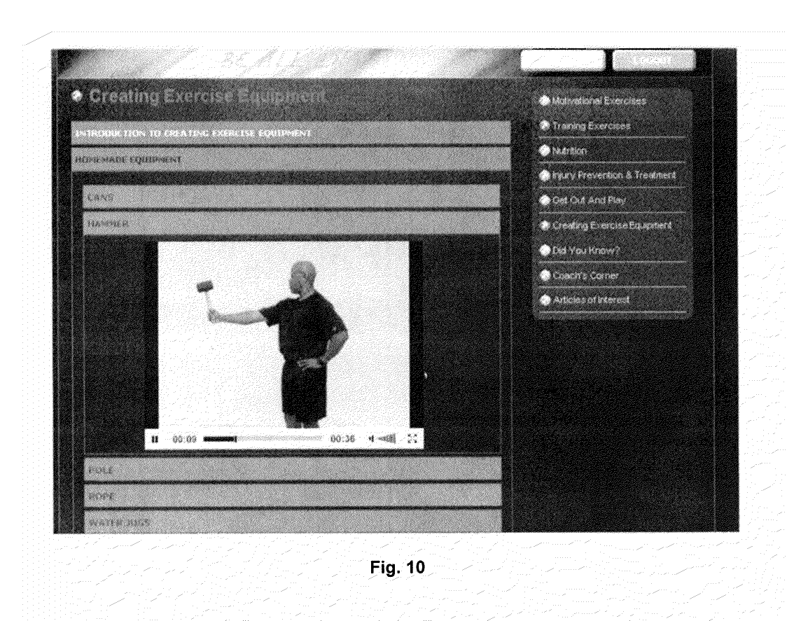

An example of a demonstration of how a user can create their own exercise equipment is displayed in FIG. 10. This Module provides the user with information and video demonstrations on how to create homemade or inexpensive exercise equipment. As seen in FIG. 10, upon selection of Options of HOMEMADE EQUIPMENT and HAMMER in the drop down selectable options windows, a user may be presented with a video demonstration of different exercises that can be performed with homemade exercise equipment, such as a hammer.

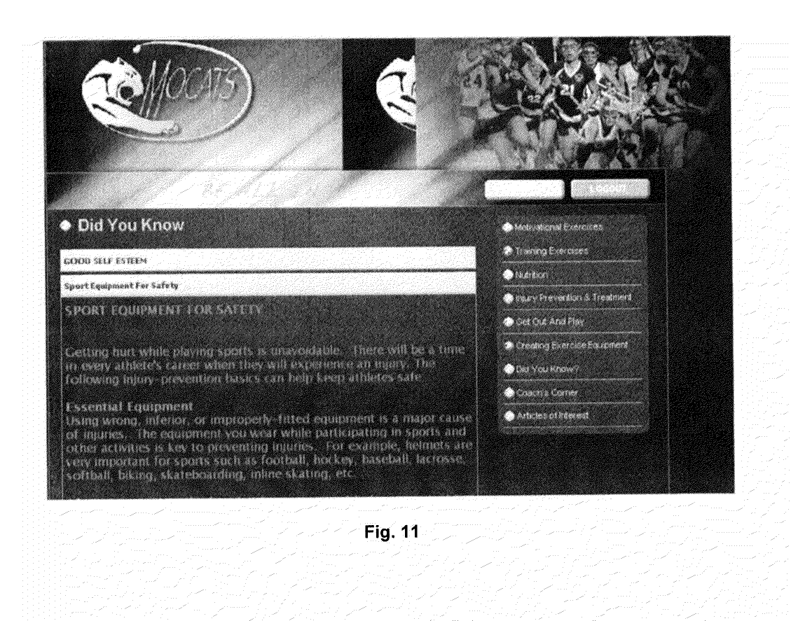

An expanded view of user selected options under the Did You Know Module being displayed on a user interface is shown in FIG. 11. The Did You Know Module may provide the registered user with information related to good self esteem, sports equipment for safety, sports injury prevention tips, staying healthy, benefits of strength training for young athletes, and national numbers for youth sports. The Did You Know Module is also important for parents and coaches of young athletes, as it provides them with information on how to support, encourage and monitor a young athlete's progress.

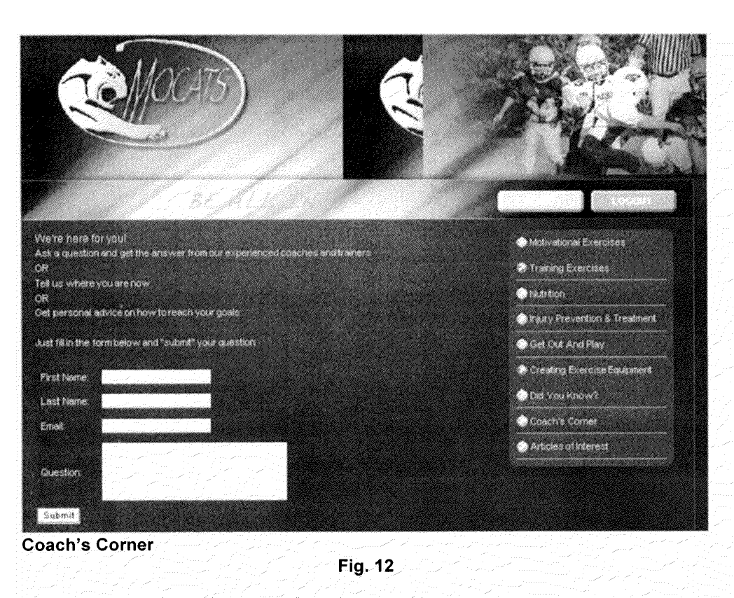

FIG. 12 is a representative display on a user interface of the interactive Coach's Corner Module of the present invention. The Coach's Corner Module of the present invention allows the user to submit questions and get answers from experienced coaches and trainers. Contact information such as email addresses, personal addresses, personal websites, or telephone numbers of the experienced coaches and trainers may be provided to the user. As shown in FIG. 12, the Coach's Corner Module allows user to type questions and provide contact information for responses onto a form displayed on the personalized homepage. Additionally, the Coach's Corner module may contain links for a registered user to upload video of the user performing exercises or training routines, or participating in an athletic activity. These videos may then be directed to the experienced coaches and trainers for evaluation. Any videos submitted by a user may be visible as selectable icons on the Coach's Corner Module, with any feedback or comments presented being displayed to the user when the icon for a particular video is selected. Videos uploaded by the user may also be evaluated as part of the user's fitness level evaluations.

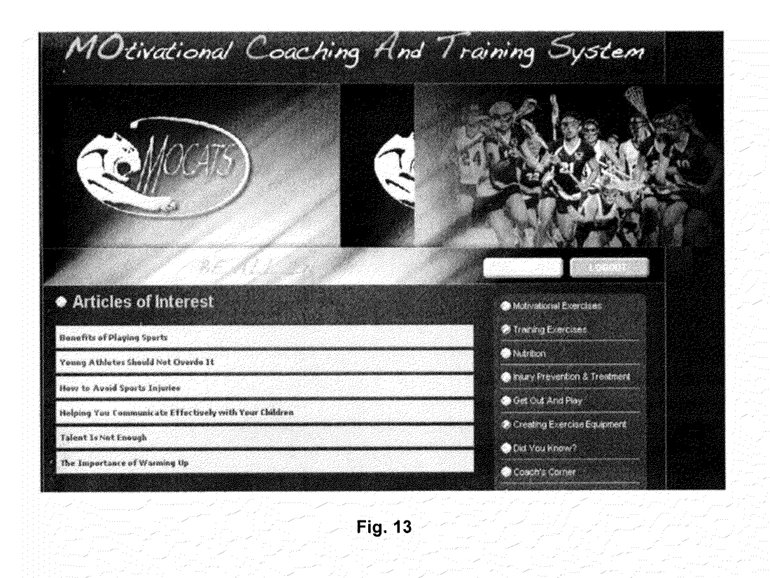

FIG. 13 is an example of the Articles of Interest Module, directed to parents and coaches of young athletes. Under this Module, users may select options on how parents can become involved in the training and fitness of their children. Registered parents and coaches may also select options providing them with information on organizing youth sports and practices, and also information to help them deal with common problems that young athletes face. Information directed to helping parents and inexperienced coaches create training programs, run practices and drills, coach athletic competitions, and understand young athletes is also provided under the Did You Know? Module (FIG. 11) of the present invention.

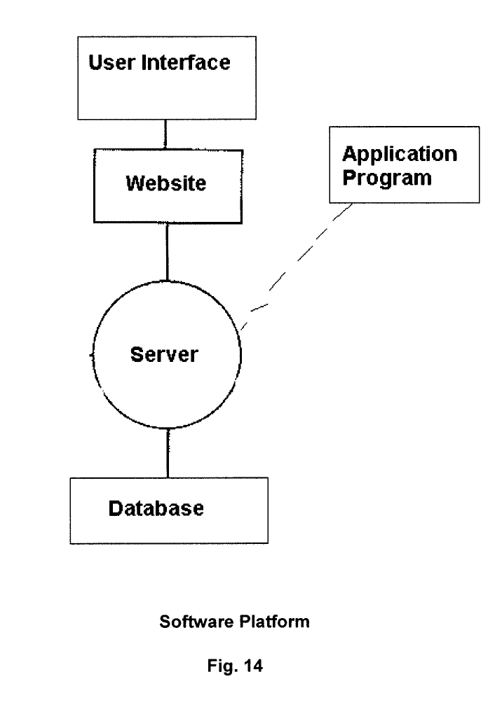

FIG. 14 is an example of a software platform and system of the present invention. The system may include a user interface, database, server, and application program. The user interface may be a computer, tablet computer, cell phone, PDA, or any other device allowing a user to access and view a webpage over the Internet. The user interface, when in the form of a computer, may contain a processor, hard drive, motherboard, I/O connections, memory, or other typical hardware. The fitness and training application program may be stored on a computer readable medium and may take the form of computer executable instructions or software that a computer can execute to control the interactive fitness program of the present invention. The program may be stored on a server, which may take the form of a single computer or multiple computers working together. The server computer may contain a processor, hard drive, motherboard, I/O connections, memory, or other typical hardware. The server may also be in communication with a database containing information used by the interactive fitness program of the present invention. The server is also in communication with the user interface, allowing a user to access the interactive fitness program through wired or wireless communications with the server.

In accessing the website based fitness program, users can connect through a personal computer, smart phone, cellular phone, or any device that allows for connection to the internet. The website based fitness program of the present invention can also be implemented as an application for a smart phone or other device that has internet connectivity. When implemented as an application for a smart phone, the user's personalized homepage automatically loads upon selecting of the application. The application further allows the user to upload information regarding completed exercises, information regarding fitness level tests, questions or comments to their virtual coach, and audio or video clips.

In addition to the personalized homepage, the web site based fitness program of the present invention may also contain additional programs accessible through the website for general student body populations or adults. The general student body fitness program accessible by a user on the website based fitness program of the present invention may allow a school, education facility, or other organization to create customized training and fitness programs based on goals or curriculum requirements. In the case of a school or organization, the website based fitness program homepage for the organization would allow the organization to upload any instructions, curriculum, lesson plans, or student and class schedules. Additionally, the education facility or other organization is able to display calendar information giving users information and notices for upcoming registration deadlines for athletic teams, practice schedules, and dates and times of athletic events. The adult program of the present invention presents users with exercises and information accessible through a personalized homepage that are beneficial to older athletes and others wanting a structured fitness and health program. The adult program personalized homepage can include daily exercise suggestions and reminders, as well as information related to specific injuries or health problems. Companies such as health care providers also have the ability to add specific training and rehab programs to the website that can be performed by their patients in order to combat injuries and health problems as well.

In addition to accessing a personalized homepage through a website address, the present invention allows for registered users to create links to their homepages that can then be contained in social media or networking sites where the users are also registered.

1. A system for using an online personalized website providing comprehensive fitness, nutrition, and training information comprising:
a user interface including a visual display;
a server at a remote location from the user interface;
a communication connection between the user interface and the server allowing the user to access data and websites controlled by the server and to send data to the server and websites;
a database accessible by the server and the user interface containing information and data related to physical fitness, training, and health; and
an application program accessible through the server, wherein the application program comprises instructions to operate a website based fitness program accessible by remote users, the website based fitness program comprising:
a personalized homepage displayed to a user upon accessing the website;
selectable Modules within the personalized homepage, where each selectable module contains textual, audio, or video information relating to various aspects of physical fitness and training and wherein each selectable Module displays options and data within the personalized homepage of the user without redirecting the user to another website.

2. The system of claim 1, further comprising a virtual coach displayed on the user's personalized homepage, wherein the virtual coach takes the form of a video-recorded human figure, an animated figure, audio communications, or text boxes appearing on the personalized homepage.

3. The system of claim 1, wherein each selectable Module provides the user with selectable options inside of windows that open within the homepage and display drop down menus of selectable options within the selected Module relating to a specific area of fitness, health or training.

4. The system of claim 3, wherein, upon selection of a selectable option, information or data in the form of text, audio recordings, or video is displayed to the user within a window that drops down from the selected option within the user's personalized homepage.

5. A method for assisting users in reaching fitness, health or training goals through interaction with an internet-accessed personalized user homepage comprising:
determining a user's current strength and fitness level;
providing a user with access to an internet-based personalized homepage through a user interface;
allowing access to various selectable Modules on the user's personalized homepage that correspond to different aspects of fitness, health and training, wherein the selection of a Module does not redirect the user to another webpage, and wherein selection of a Module opens a drop down menu of further selectable options within that Module displayed on the user's personalized homepage;
providing access to selectable options within each Module, wherein the options open in a drop down menu within the selected Module on the user's personalized homepage;
providing a virtual coach on the user's personalized homepage, wherein the virtual coach guides the user to specific Modules and selectable options within each Module; and
guiding the user to make selections in the various Modules and options in order provide the user with displayed text, audio recordings, or video to instruct the user on ways to improve fitness and health or to train for specific athletic activities.

6. The method of claim 5, wherein the virtual coach takes the form of a video-recorded human figure, an animated figure, audio communications, or text boxes appearing on the personalized homepage.

7. The method of claim 5, wherein the personalized homepage is modified to provide information directed specifically to young athletes and/or school physical education programs.

8. The method of claim 5, wherein the personalized homepage displays video demonstrations of specific exercises or activities related to the user's determined strength and fitness levels upon selection of options within the various Modules.

9. The method of claim 8, wherein the personalized homepage tracks completion of various selected options within the various Modules by the user and guides the user to additional options and Modules based on options already completed.

10. The method of claim 8, wherein the personalized homepage provides links for the user to send, through the user interface, textual data or video uploads.

11. A system for using an online personalized website providing comprehensive fitness, nutrition, and training information comprising:
a user interface including a visual display;
a server at a remote location from the user interface;
a communication connection between the user interface and the server allowing the user to access data and websites controlled by the server and to send data to the server and websites;
a database accessible by the server and the user interface containing information and data related to physical fitness, training, and health; and
an application program accessible through the server, wherein the application program comprises instructions to operate a website based fitness program accessible by remote users, the website based fitness program comprising:
a personalized homepage displayed to a user upon accessing the website;
selectable Modules within the personalized homepage, where each selectable module contains textual, audio, or video information relating to various aspects of physical fitness and training and wherein selection of a Module directs the user to a new webpage with additional selection options specific to that Module.
